(19) United States
(12) Patent Application Publication
(10) Pub. No.: US 2014/0279149 A1
(43) Pub. Date: Sep. 18, 2014

(54) METHOD AND DEVICE FOR REVERSE AUCTIONS TO FACILITATE REQUESTING AND OFFERING OF SERVICES

(71) Applicant: Christopher Scott Barlow, Danville, CA (US)

(72) Inventor: Christopher Scott Barlow, Danville, CA (US)

(21) Appl. No.: 14/196,524

(22) Filed: Mar. 4, 2014

Related U.S. Application Data
(60) Provisional application No. 61/777,119, filed on Mar. 12, 2013.

(51) Int. Cl. G06Q 30/08

(52) U.S. Cl. CPC G06Q 30/08
USPC 705/26.3

(57) ABSTRACT

A system and method to secure the best bid for a service requester and contract price for a service provider is provided in an Internet or Intranet based reverse auction. Service requesters, or customers, provide details of the work that needs to be completed and service providers give their best bid and the lowest price that they can do the work for as auction bids. The reverse auction is given a certain time period in which to run and bids can be updated in real time, or through prepared reserve bids, so that the Service Provider with the lowest bid secures the contact information of the Service Requestor in exchange the Service Requestor receives a competitive quote for the work. The auctions can be publically open to all qualified contractors or can be private, by invitation, to certain Service Providers.

### CROSS-REFERENCES TO RELATED APPLICATIONS

The present application is a continuation of provisional Application No. 61/777,119; filed on Mar. 12, 2013, the full disclosures of which is incorporated herein by reference.

### FIELD OF THE INVENTION

The present invention concerns a method for securing a high value service at the lowest cost via a bid process. More particularly the present invention concerns an on-line reverse auction process where a job is secured by having the lowest bid and best credentials to do the work.

### BACKGROUND OF THE INVENTION

Service jobs are often secured by word of mouth; good Service Providers often receive additional or new work by establishing a good reputation and nurturing customer satisfaction within a community amongst friends, families and neighbors. However, there is always the case of persons who do not know how to find and solicit work from quality Service Providers or persons who have had good experiences with Service Providers who are not asked for a reference. Further, there are other situations where a Service Provider or other type of laborer is desired but the qualifications are not easily determinable and/or the costs are prohibitively expensive. On the other side of the equation, there are many qualified Service Providers or other laborers who do not have access to evaluate service job requests and provide quotes in a timely manner.

Our current services industry lacks an effective and transparent global market place that brings consumers and service businesses together through a process optimized for today's economy. Existing mechanisms are clunky and inefficient, and do not give consumers an efficient marketplace with competitive prices for services. Both consumers and service providers have limited or no access to sophisticated tools and market information to make effective pricing and business decisions.

It would be helpful, both to Service Providers and Customers who need work done, to have a system and method of having access to a single and singular platform that acts as a marketplace for posting and awarding service jobs, delivering value to both the Service Provider and Service Requestor. The platform would need to be intuitive for consumers and service providers to connect and fulfill their needs. It would solve the consumer problems of getting competitive pricing for services by providing an Internet marketplace for service business participants to engage consumers and transact instantly. The platform would provide consumers with the knowledge and transparency necessary to make informed choices. The platform and method would provide those needing the performance of service jobs with competing Service Provider quotes that homeowners and businesses could evaluate, and thereby compare one Service Provider to another in quality, cost and previous customer satisfaction. Security and overall Service Requestor satisfaction would be further insured by allowing filtering on key qualifications of both the Service Provider and Service requesters (for example elements such as past performance, overall satisfaction, and testimonials) that can be viewed and shared with all users, via elements of the method of the present invention.

Objects and advantages of the present invention will become apparent as the description proceeds.

### SUMMARY OF THE INVENTION

In accordance with the present invention, a method for offering and securing services via an online reverse auction portal is provided. Service Providers provide the services at a rate acceptable to a Service Requestor who is the receiver of the services provided. The method comprises the steps of providing an interactive web page on a computer network comprising servers and communications means; the web page additionally comprises a Service Provider page and a Service Requestor page. In addition, the method includes providing a means for one or more Service Providers to register as a provider of services on the interactive web page and providing the requestor of services a request page location on the interactive web page to list a request for services, including providing the necessary parameters for the services. The method includes providing the one or more provider of services access to the request page location and providing a time period for the requested services to be offered. The provision of these elements then allows a requestor of services to enter parameters for services-required and start the time period. Providers of services can review the services requested and place a first bid for the desired fees for their services. Subsequent lower bids may be submitted in the same service request event during the provided time period. Upon completion of the time period the requestor of services is notified of the lowest bid among the service providers among the bids provided by the one or more service providers.

In embodiments of the invention, the method provides a means to exchange consideration such that the final bid comprises either a contract for services or, as desired, a quote from the Service Provider, which can be accepted or declined, as will be explained below. The method allows the Service Provider to decrease their second and subsequent bids prior to the end of the time period. In the practice of the method, the requestor of services can create and save their customized templates for services for use in the method and then reuse the template for other services required. A database of templates of services is maintained and templates can be recalled for use in the method. The method can be practiced, both by receiver and provider, on a laptop computer, desktop, tablet, smartphone or any other device having access to the Internet.

In a preferred embodiment of the present invention the provider and receiver of the services use the quote created as a result of the final bid as the basis of feedback, positive or negative, relative to the provider and receiver of the services. For example, if a given quote is accepted and the work is done as noted in the web page the Service Provider is given positive feedback. If the quote is not honored or otherwise not met, the Service Provider could be given negative or neutral feedback. In the same way, if the Service Receiver follows through and pays in accordance with the quoted service fees or concomitantly, does not pay at the quoted rate or cancels the project after receiving a final bid/quote, the Service Receiver will also receive appropriate feedback.

The method of the present invention comprises a reverse auction in real time. As the method is practiced in real time a provider of services bid can monitor in real time and lower subsequent bids as desired so as to maintain the first position in the auction.

In some embodiments, the method includes templates having service description information therein such that the elements of the auction that are automatically populated with information provided by service requestors and a database can thereby also be created.

In one form, the invention is a method and device for reverse auctions to facilitate requesting and offering of services. More specifically, one embodiment of the invention may comprise a reverse auction focused on service areas as a business model and accessed via a website on desktop or mobile platform. Customers may post requests for proposals for various services and receive competitive quotes from service providers via the online site. Some of the services that may be requested are provided by such professionals as painters, plumbers, carpenters, electricians, and others. In one embodiment, the primary focus is for residential and small business customers and the services they require. In yet other forms of the invention, the target user base may be expanded to include other customers. Customers receive competitive quotes from service companies via an online and in real time reverse auction website.

Additionally, in general, one form of the invention may include one or more various steps of: a) Using live bid graph for both Service Providers (SP) and Customer to view a reverse auction service event. A live graph for the customer and SP will show each the dynamic relationship of the live bid event. b) An auto-bid function—the SP can set a lowest bid amount and allow the system to auto bid in his/her place. c) A website will allow SP to pre-set their lowest acceptable bid and let the system bid on their behalf d) Process instant job lead notification to SP via email/phone/text; website will automatically notify the SP of a service request event that has been posted in which the SP has pre-registered as having an area of expertise and interest. e) Scope of Work job templates; the system will provide accessibility to a growing list of hundreds of unique job Scope of Work templates that are pre-populated into the service request event from which the customer can either accept or edit to customize further. f) Customizable Company/Service Provider Profile Page; profile pages allow companies to create their own profile pages that advertise themselves to potential customers (portfolio pictures, summary, customer testimonial, oversight, number of jobs, etc.). g) Process Customer Award program—customer eligible to receive money for using service as part of Customer Award program (points awarded each time a Customer provides post-job feedback on the Service Provider awarded the service request event). h) Service Providers or Customer profiles are pre-registered in the system, information bought and obtained via a 3rd party marketing database company, which compiles and sells customer/service provider lists, but not activated until the service provider or customer clicks on previously sent email link acknowledging/accepting registration, opt-in function.

A more detailed explanation of the invention is provided in the following description and claims and is illustrated in the accompanying drawings.

### BRIEF DESCRIPTION OF THE DRAWINGS

FIG. 1 is a flow chart showing the steps of one embodiment of the method of the present invention.

FIG. 2 is a schematic representation of the elements and population steps of a database for use with the method of the present invention.

FIGS. 3A, 3B and 3C are schematic representations of the elements and population steps of creating a new event from the point of view of the purchaser of services.

FIG. 4 is a schematic representation of the elements and population steps of recreating a previous event from the purchaser's point of view.

FIG. 5 is a schematic representation of the elements and population of a dashboard panel of the present invention, from the point of view of a service provider.

FIGS. 6A and 6B are a graphical representation of the combination of FIGS. 2, 3A, 3B, 3C, 4 and 5, the details of which are clearer on the various Figures, respectively.

FIGS. 7A through 7H are screen shots of sample web pages used to provide the method of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects. It should be further understood that the title of this section of this application (“Detailed Description of an Illustrative Embodiment”) relates to a requirement of the United States Patent Office, and should not be found to limit the subject matter disclosed herein.

Referring to the drawings, elements of the method and device of the present invention are shown in flow chart form, the entirety of which is combined into FIGS. 6A and 6B which is an embodiment of the steps of the device and method of the present invention; which elements are more clearly shown in the flow charts of the earlier numbered figures. In addition, there is included herewith, in FIGS. 7A through 7H images showing embodiments of one type of Internet web site pages that can be used to implement the present invention. References to FIGS. 7 may be made interspersed with a discussion of the invention as a whole.

In FIG. 1 there is shown a schematic representation of the home page 10, which includes a customer registration page 12, and a service provider registration page 52, both of which will be described in greater detail below. Customer registration page 12 includes an instruction page 14, giving the rules and philosophy of the invention from the point of view of the party seeking services, these being shown in more detail in the “submit a service request flow chart” 16. Service provider registration page 52 also includes an instruction page shown in the “place a bid flow chart” 54, giving similar rules and philosophy of the invention, but in this instance, from the point of view of the party offering services. The details shown in FIG. 1 are typical of any web page for any type of service or product and the parameters thereof will be known to anyone having entered data onto a web page to register for goods or services. More details of the method of the present invention are shown in the remaining figures. It will also be seen that each of the figures is an element of one large flow chart, shown in FIG. 6, with great detail shown in each page. While the figures all stem together, it will be understood that persons having ordinary skill in the art can make modifications to each chart and/or each element of the charts while maintaining the functionality that is the present invention and not deviating from the novel scope of the present invention.

In the customer registration page 12, after reviewing instruction page 14, the customer is sent through a series of steps, in a flow chart 16, that will lead to a complete request for service, which is shown in FIG. 1 as boxes needing information and as a customer job flow chart 18 showing an overview of the process as “start” 18a, “launch service request” 18b and “job finished” 18c. Additionally, each of the steps of customer job flow chart 18 are fleshed out laterally, on service request flow chart 16, such that: Start 18a has the steps “register”, “identify service category & geographical radius” and “write service/request customized event”; “Launch Service Request” 18b, includes the steps “invite service providers to participate”, “launch event” and “service providers bid against each other for job”; and Job Finished 18c includes the steps of “select and award auction”, “service work performed” and “evaluate service provider”. It will be understood that this flow chart and the elements indicated therein are exemplary and that an auction of the present invention can be set up with more or fewer steps, and/or that these steps can be combined or broken into more steps without departing from the novel scope of the present invention.

In the service provider registration page 52, after reviewing instruction page 54, the service provider is sent through a series of steps, in a flow chart 56, that will lead to a complete request for service, which is shown in FIG. 1 as boxes needing information and as a place a bid flow chart 58 showing an overview of the process as “start” 58a, “win service auction” 58b and “perform work and get paid” 58c. Additionally, each of the steps of customer job flow chart 58 are fleshed out laterally, on place a bid flow chart 56, such that: Start 58a has the steps “register”, “locate open auctions in area or bid on private event request from service requester” and “review scope of work for service request”; “Win service auction” 58b, includes the steps “service auction begins”, “place competitive bids for service request” and “lowest bidder? Pay. Service auction awarded”; and Perform work and get paid 58c includes the steps of “contact information of service requestor sent”, “service work performed” and “evaluate service requestor”. It will be understood that this flow chart and the elements indicated therein are exemplary and that an auction of the present invention can be set up with more or fewer steps, and/or that these steps can be combined or broken into more steps without departing from the novel scope of the present invention.

Referring now to FIG. 2, the steps for customer and service provider use of the system and method of the present invention are shown. From home page 10 the user selects whether the user is a customer 12 or a service provider 52. If customer 12 is chosen by the user, basic registration information 20, comprising, for example, contact information 20a and profile preferences 20b can be entered and/or updated. The customer 12 is asked to log-in 22 in a manner known to persons having ordinary skill in the art and then can select whether to create a new event 24 or copy a previous event 25, both of which will be described in greater detail below. In addition, customer 12, upon signing in, can select to do research, through a web search interface 26 provided having access to a premade and continuously updated database network 100. Search interface 26 can be constructed to include a listing of service providers in a local area 28 which can, in one embodiment, provide the ability to search by sub-categories 28a, which could include type of trade, size of provider and ranking based on prior customer review, among other things.

The steps for the service provider 52 are also shown on FIG. 2 and it will be seen that once the information from service provider 52 are added to the system, information therefrom can then be used to populate the database network 100, which can then be used by customer 12 in the manner described, and which will be described in greater detail below.

Service provider 52, once in the system, is required to add general information 60 concerning provider 52, such as contact information, profile information (such as trade, experience and the like), preferences respecting the types of customers 12 provider prefers to work with, and its qualifications (licenses, bond, Better Business Bureau information and the like). Provider 52 can also update its profile at that time, such as if provider 52 is a returning user. Once registered, provider 52 can proceed to the dashboard panel 150 (as shown in FIG. 5, and described in greater detail below) or review information in the database network 100. It will be seen, as described above, that upon entering or updating its profile, these elements in a preferred embodiment are caused to update the database network 100.

Database network 100 is shown in FIG. 2 as an exemplary embodiment, it will be understood that any form of database used to house the information required and/or desirable to an auction system of the present invention can be used without departing from the novel scope of the present invention. In the illustrative embodiment, a database network 100 is provided for the use of users of the present invention and can include direct data 102 a database service 104 and storage 106 (here shown as internal storage, however it will be understood by persons having ordinary skill that external storage, including cloud storage, can be utilized without departing from the novel scope of the present invention). It will also be seen that bid-data-analysis 108 can be performed in the database network 100 such that such data is gathered, compared to direct data 102 and stored for analysis by the users of network 100. In addition, a data search engine 110 can be provided for use by users of the system of the present invention as shown in FIG. 2, to search events that can be stored in service categories such that the search can be made within the categories or even sub-categories as desired; in addition, the search engine 110 can provide the user, on its computer screen, a live events page 110a showing the results of the search, with such abilities as filters to allow the narrowing of the results and a view of the results in the manner desired. The inter-connectability of the elements shown in FIG. 2, in the various arrows indicated on the drawing, show that the system is designed to provide as much information to the parties as is possible to facilitate the statement of work and bidding process. It will be understood that modifications can be made to the various elements without departing from the novel scope of the present invention. It will be seen that the elements of FIG. 2 are shown in more detail in others of the drawing figures: for example, as shown, create a new event 24 is shown in FIGS. 3A and 3B; copy a previous event 25 is shown in FIG. 4; and dashboard panel (of service providers) is shown in FIG. 5, and all are explained in greater detail below.

Referring now to FIG. 3, specifically FIG. 3A, there is shown a detailed illustrative method for a customer 12 to create a new event 24 which can be posted for bids. The new event is sometimes referred to as a statement of work (SOW). It will be seen in drawing FIGS. 3-5 that numerals 1 through 6 are provided within sections to indicate some of the important parts in the creation, initiation and running of the system and method of the present invention. Further, in this description, reference will be made from time-to-time to enumerated steps, steps 1-4, shown in FIGS. 3A and 3B.

In step 1 (FIG. 3A), of the event creation process 24, the customer 12 can select whether the event will be a public event 124 or a private even 224. Referring to FIG. 7A, there is shown a screen shot of a page that could be used in the present invention to either create a new event or copy a previous one and to make such an event private or public, as will be described in detail below.

In one embodiment, as noted, the method and device provide the option for the Service Requestor 12 to choose if their service request event will be “Public” or “Private”. Service requests that are posted as “Public” allow one or more registered website Service Providers 52 the ability to view and bid on the event. In a preferred embodiment there are no pre-requisite conditions or limitations as to the visibility of the “Public” posted service request events, however, persons having ordinary skill in the art can make conditions in this regard as needed, such as to allow non-registered providers to view the request and provide instruction on how such providers can register to use the method of the invention.

Conversely, in the preferred embodiment, Service Requestors 12 who choose to post their service requests as “Private” are limited to receiving bids from only the registered website Service Providers 52 they select from the search listing or to which specific invitations are sent to bid for the services. Within the Service Provider search (Step 3B—see, FIG. 3B, of Event Creation), Service Requesters 12 choose which Service Providers 52 to invite into the private service request event. Only those service providers selected by the service requestor can participate and bid in the event.

It will be seen in FIG. 3A that the steps for creation of public events 124 and private events 224 are similar, and similar numbers are used to identify the elements. The user, in the illustrative method, will select the service category 126, 226, which in some embodiments can be broken into sub-categories as desired. Once approved 128, 228 by the user, the event is created 130, 230 in step 2 of the method, and the auction rules are established 132, 232. It can be seen that the parameters of the job can be entered at this time, including such things as the event title, the start and end times, work completion deadline and information on the location of the work site. The user can then review 134, 234 the statement of work (SOW) created and edit as needed including pre-populated sow's 134a, 234a.

It will be understood that one important benefit of the Public vs. Private invite feature is that it empowers the Service Requestor with both pre-launch event knowledge about eligible pool of registered Service Providers while also providing the flexibility to meet his/her unique job task needs. For example, there may be situations in which a Service Requestor may identify as part of the service request event creation process an abundant listing of able and qualified Service Providers in which he/she is able to preview profiles and not have any preference as to which ones bid or win the service request event. In such situations, where a Public event is chosen, price is typically the primary driver. Conversely, in the same situation, a Service Requestor may be selective about the particular attributes, past-performance, and skills of those bidding on his/her service request. In such situations, the Service Requestor may choose a “Private” event option so as to pre-filter based on individual needs, etc.

In one form, a feature of the invention consists of maintaining a database with pre-built Scope of Work (SOW) templates, as shown in FIG. 7B, for thousands of unique service requests. Because the general population typically will not have the experience, the time or knowledge of how to write detailed SOW specific to a job, task or project, the key benefit to both the Service Requestor 12 and the Service Provider 52 is clarity in job expectations and key deliverables. Establishing clear job expectations and deliverables is critical to the reverse auction process so that Service Providers have clear understanding of what is being asked of them. Pre-built built SOW templates enable the Service Requestor to have the details and job deliverable expectations clearly defined so that Service Providers are interpreting the job task the same which ensures the reverse auction results in competitive bids. Often, uncertainty resulting from a poorly written SOW results in Service Providers placing uncompetitive bids due to lack of clarity and unclear requirements and expectations. This can result in a Service Provider charging a premium above what they would have charged to account for their perceived “risk” and other unknown's to cover their own costs if they are awarded the work. This same phenomena and behavior is observed in the insurance industry to account for uncertainty when taking on unknown risk.

Referring again to FIG. 3A, then, it will be understood that the auction rules 132, 232 can be generated as part of the pre-built SOW templates or can be generated by the user at the time of making a new or unique event 24. In the creation of the rules, such items as event title 136, 236; start time 138, 238; bid ranges 140, 240; auto extend times 142, 242; contract work completion date 144, 244; time zone 146, 246; documents uploaded (such as permits, engineering documents, etc.) 148, 248; and location information 150, 250, for example, can be entered. It will be understood that other and different information or less information can be provided without departing from the novel scope of the present invention. In the alternative, as described above, these areas of information can be auto populated when a prior SOW or a pre-built SOW is used, as shown as Event Creation 130, 230—step 2 (A,B—in FIG. 3A). The ability to review/edit 152, 252 the SOW is also an element of the programs ability to create the new event 24 or SOW.

In some embodiments of the present invention, the “create a new event” 24 template can include elements such as helpful hints database 154, 254 and review and approve elements 156, 256. FIG. 3A then shows that the next step in the process continues on FIG. 3B.

Two other aspects of the SOW templates provide additional customization for the Service Requestor to further define their own specific service request event. First, all SOW templates are customizable by the Service Requestor 12. As such, the Service Requestor 12 may edit the text as needed. Additionally, the Service Requestor 12 may upload documents/photos to the service request scope of work to further define, clarify and expound upon the service request expectations, deliverables and requirements, as will be described in greater detail below.

Secondly, as each launched service request event is proprietary to the site, regardless of the Service Requestor customizing a template or creating their own from scratch, the site will become a repository and library of SOW templates for Service Requestors to reference and use (if so chosen). As such, the site will enable the Service Requestors to use any previously created and posted SOW that was originally created, edited or modified by a Service Requester, thus creating a database of millions of unique SOW templates that all Service Requestors can mutually use, share and benefit from.

Referring now to FIG. 3B, as a continuation of the create a new event chart 24 begun on FIG. 3A, yet another feature of a preferred embodiment of the present invention is shown. The provider invite 158, 258 method is shown (as step 3) and consists of a method and tool to search, filter and quickly and efficiently identify potential Service Providers 52 to participate in a Service Requestor's service request event. One of the unique aspects and challenges of posting a service request on a reverse auction site is the Service Requestor's challenge to efficiently and accurately ascertain the pool of potential Service Providers who might bid on a project, job or task. Unlike other auction sites that are geared towards goods (such as eBay), the service auction site of the present invention is different in that it takes into account a different set of search criteria from which to filter the results. First, before the Service Requestor 12 enters the Service Provider search screen 160, 260, the requestor 12 can first choose a main category (for example, home-interiors) and then subsequently a sub-category within (for example, plumbing services) not shown.

From there, continuing in FIG. 3B, the Service Requestor 12 can elect to choose one of the pre-built SOW templates covering a variety of different, unique and specific type of jobs or tasks (see FIGS. 7A and 7B). Another option is for the Service Requestor to create their own.

At this point the Service Requestor enters the Search Service Provider screen 160, 260, as Step 3A in FIG. 3B. The Service Provider search screen 160, 260 has several adjustable/selectable Service Provider attributes 162, 262, etc. from which the Service Requestor can filter their list. The “geo-location” service provider search is one such criteria “layer” by which the database reviews filters and pulls-up results. The geo-location filter field functions by searching for Service Providers in a radius (adjustable sliding scale of 0-50 miles) from the Service Requestor's previously entered default user profile zip code. All other search/filter options being left alone, the system will pull all site registered Service Providers within the designated radius that provide services per the sub-category previously chosen (i.e. Plumbing Services). It will be seen that the default zip code, originating from the Service Requestor's profile, is changeable by the Service Provider at anytime in the service request event, thus enabling the Service Provider to launch events in other geographical locations if on vacation, business trip, etc. This is another variation of the invention.

As the Service Provider search tool has several criteria from which the database filters and pulls-up results, there are additional “layers” by which the Search Service Provider invention works and functions making it distinguishable from other search tools. Besides the Category=>Sub-Category & Geo-Location filters describe above, the remaining are additional filter criterial 62, 262; one or more of which may be used by the invention providing additional “layers” and dynamic search capabilities, it is noted that each criteria may not be used in every embodiment of the invention:

Service Provider Rating: Each Service Provider has a star rating as provided by Service Requestor feedback on previous work performed. The star rating can, in embodiments, range from 0-5 stars in 0.5 star increments. The Service Requestor then, for example, use a sliding scale to select a minimum star rating such that the system will pull all Service Providers that provide plumbing services within the selected radius that have a minimum Service Provider star rating of at least, for example, “x”.

Licensed: As part of the registration process, each Service Provider may indicate on their profile if they are licensed in their professional area of service (the lack of an indication can be taken as a negative inference). The Service Provider can select one of three options, Yes, No, Not Applicable. Based on the Service Provider's self reported status and the Service Requester search criteria, the results will filter to correspond to selected preference.

Insured: As part of the registration process, each Service Provider must indicate on their profile if they are insured in their professional area of service. They can select one of three options, Yes, No, Not Applicable. Based on the Service Provider's self reported status and the Service Requester search criteria, the results will filter to correspond to selected preference.

Bonded: As part of the registration process, each Service Provider must indicate on their profile if they are bonded in their professional area of service. They can select one of three options, Yes, No, Not Applicable. Based on the Service Provider's self reported status and the Service Requester search criteria, the results will filter to correspond to selected preference.

BBB: As part of the registration process, each Service Provider must indicate on their profile if they are members of the Better Business Bureau (BBB) in their professional area of service. They can select one of three options, Yes, No, Not Applicable. Based on the Service Provider's self reported status and the Service Requester search criteria, the results will filter to correspond to selected preference.

Other: In yet other embodiments of the invention, there may be additional aspects added as part of the registration process for each Service Provider to indicate on their profile which could be used as part of the Service Provider search invention.

An example of a web-screen showing how these criteria can be shown to the user is provided in FIG. 7C. The combination of these individual search criteria makes the method and website unique and unlike what has been achieved in the prior art with Service Provider search tools. The option and flexibility of the Service Requestor to define their specific and own parameters across a specific category, specific sub-category, specific distance by radius, licensed, insured, bonded and BBB is a distinguishing functionality that will enhance and facilitate both the user experience and decision making. In FIG. 7C (and in FIG. 3B) it can be seen that the search result lists the results 162c (262c) for each service provider along with the ability to view the Service Provider's “profile” by selecting a button 162d, 262d next to the results listing. This function further allows and enables the Service Requestor to explore additional details on a Service Provider. The Service Provider “profile” opens up in a separate window upon selection. In addition, the sender profile can be marked 162e by a potential Service Requester so as to have it available for an auction. In this manner, if a desired Service Provider is marked, the Service Requester can remember to send an invitation to that Service Requester for a particular event. In particular, in a private event, the Service Receiver will want to select particular Service Providers to invite to the event. In a public event, while all Service Providers will see that the event is available, the Service Requester can still, by marking the particular provider, make a special invitation to that Service Provider. Review and approval tasks are also provided.

Referring again to FIG. 3B, event launch step 4 is shown. Step 4 includes a review event summary and details 164, 264 chart as the final entry phase prior to having bids. It will be seen that in this aspect of the method the user 12 can review the auction event rules 166, 266; review the SOW 168, 268 and review the selected service provider notification 170, 270 as the approval steps to continuing to the customer bid dashboard 174, as shown in FIG. 4.

Having explained how a customer creates a new event, both private and public, it will be understood that templates for events, both created for the method and encompassing later events previously created that are repeatable can be included in the method of the present invention, as noted above. One embodiment of the invention enables Service Requestors 12 to duplicate a previously created service request event. An important benefit of duplicating a previous service request event is time savings. As compared to recreating the same service request over and over again, the Service Requestor 12 is able to efficiently duplicate and post for bidding exactly the same request from the Service Requestor's archived listing of historical events.

Another strategic benefit of copying a previous event is assurance of accuracy. Since each individual event has a detailed and customized written scope of work, each event is individually reviewed, edited and confirmed for accuracy before posting. The ability to quickly duplicate the details of a previous unique and customized service request event gives assurance to the Service Requestor their previous event can be leveraged resulting in both efficiency and accuracy.

Copying a previous event allows the Service Requestor 12 to use his/her previous event as a template from which to edit/tweak as necessary before posting, enabling the Service Requestor to post his/her request in a matter of seconds rather than minutes. As shown in FIG. 3C, a template 172 for copying a previous event is shown. It can be seen that this creation is secondary type of step 1, previously described with respect to FIG. 3A. The user 12 will select first whether the event is private 124a or public 224a and then review archived events 172a to select the one most like the planned event 172. Criteria for classifying archived events 172a are shown as event #, category, sub-category, date of event, status, winning service provider are made available and searchable, in a manner known to persons having skill in the art. The results of the search are displayed 172b, the user 12 can then select 172c the event and duplicate 172d it—changing parameters as needed to update the event. Thereafter, step 2, event creation 130, 230 as shown in FIG. 3A is followed to complete the bid process.

Yet another form of the invention may include providing a live dashboard panel of each RA (reverse auction) bid event. The dashboard panel is a location in which both the Service Provider and Service Requestor can review the status of the reverse auction event dynamically in a real-time-basis. Although similar, the Service Requestor Dashboard panel 174 (FIG. 4, FIGS. 7E and 7F) and Service Provider Dashboard panel 150 (FIG. 5, FIG. 7G) are different. FIGS. 7 show images of potential web pages showing the various dashboard panels.

The Service Requestor bid dashboard panel 174 may consist of 1, 2, or 3 individual tabs (as required or desired) from which the Service Requestor can toggle back and forth. The subject of this invention most specifically focuses on the first tab, Tab 1: Summary of Event 176. In reviewing FIG. 4, it will be seen that this element comprises:

Tab 1: Summary of Event 176: Within this panel, the Service Requestor 12 can view a number of attributes specific to the service request event including:

Best Bid 176a: “Best Bid” field comprises the name of the Service Provider who at that point of time in the RA has submitted the lowest bid.

Countdown Clock 176b: “Countdown Clock” field is a clock in DD/HH/MM/SS format counting down real time to the end of the service request event.

Savings 176c: “Savings” field calculates the Service Requestor dollar savings for the event as calculated as the difference between the highest bid to the lowest current bid.

Auction Details 176d: “Auction Details” summarize the service request event creation selections and parameters made by the Service Requestor of the reverse auction in place, namely:
Name of Service Request Event
Type of Auction (Public vs. Private)
Auto Extend Time
Min/Max Bid Reduction Amount
Start/End Time of Auction
Start/End Time of Work Completion

Live RA Bid Status Table 176e: “Live RA Bid Status Table” ranks in order the lowest bidders on a real-time-basis along with the Service Provider name, Distance between the Service Requestor's profile zip and the Service Provider's profile zip, Service Provider Rating, Licensed, Bonded, Insured, BBB status, Service Provider profile button and the Last Bid Time (MM/DD/HH/MM/SS).

Live RA Graph Service Requestor 176f: “Live RA Graph” is a real-time graph displaying the bidding progression. The graph corresponds to the calendar date and timeframe (start and end time) of the event as previously selected on the service request event creation screens. The timeframe of the event runs along the x-axis (horizontal) and the service provider bid amounts run along the y-axis (vertical). The historical bidding progression of the lowest five (5) Service Providers who have bid will be displayed by a dot for each bid submission with lines connecting each Service Provider's subsequent downward bid by a line. Each Service Provider will have their own distinguishing color on the graph so that the Service Requester can visually compare and see the progression of the RA event. If subsequent Service Provider(s) move into one of the top five lowest bidders, the system will re-calculate the new ranking of Service Providers bidding on the event and replace one of the previously five (5) Service Providers on the graph. This same process will occur each time there is a newly submitted bid until the end of the service request event. The line chart will correspond to the “Live RA Bid Status Table” described above.

Referring now to FIG. 5 (and FIG. 7G), the Service Provider bid dashboard panel 150 consists of 1, 2 or 3 individual tabs from which the service provider can toggle back and forth. The subject of this invention most specifically focuses on the first tab, Tab 1:

Summary of Event 152.

Tab 1: Summary of Event 152: Within this panel, the Service Provider 12 can view a number of attributes specific to the service request event.

Current Rank 152a: “Current Rank” field comprises the ranking of the Service Provider 52 in the said RA event as compared to other Service Providers. The Service Provider 52 with the lowest bid shall be ranked as #1 and so forth. Service Provider 52 can only see their own rank, not the name or rank of other service providers.

Countdown Clock 152b: “Countdown Clock” field is a clock in DD/HH/MM/SS format counting down real time to the end of the service request event.

Auction Details 152c: “Auction Details” summarize the event creation selections and parameters made by the Service Requestor of the reverse auction in place, namely:
Name of Service Request Event
Type of Auction (Public vs. Private)
Auto Extend Time
Min/Max Bid Reduction Amount
Start/End Time of Auction
Start/End Time of Work Completion

Live RA Service Provider Bid History Table 152d: “Live RA Service Provider Bid History Table” is a running record of the Service Provider's own bid history within the service request event. The table only shows the Service Provider's own bidding history and not that of competitors. The table shows the amount bid, the corresponding rank in the event when bid submitted, and the Last Bid Time (MM/DD/HH/MM/SS).

Live RA Graph Service Provider 152e: “Live RA Graph” is a real-time graph displaying the bidding progression. The graph corresponds to the calendar date and timeframe (start and end time) of the event as previously selected on the service request event creation screens. The timeframe of the event runs along the x-axis (horizontal) and the service provider bid amounts run along the y-axis (vertical). The historical bidding progression of the Service Provider's own bidding will be displayed. The Service Provider will not be able to view or display other competing Service Provider's bidding on graph. The line chart will correspond to the “Live RA Service Provider Bid History Table” described above. Service Provider's own bids will be displayed by a dot for each bid submission with lines connecting each Service Provider's own subsequent downward bids by a line.

As the both the Service Requestor 174 and Service Provider dashboards 150 each provide real-time graphical and informational service request event display content, the benefits to each are enormously beneficial in creating a transparent marketplace for auctioning services. The Service Requestor and Service Provider dashboards are critical tools to finding the economic equilibrium between the buyer and seller of services in a way that allows transparency in the process while protecting the confidentiality of sensitive information of the Service Provider and Service Requestor during the event process.

In addition to the above, one embodiment of the invention may consist of the Service Provider 52 choosing between a manual bid input process 200 or an auto-bid input process 202 to place bids on live service request event. Within the Service Provider dashboard panel (all three tabs) 150, the Service Provider has the choice to place a “manual bid”. A manual bid by definition is typing in a dollar value for the said services as described in the bid, and upon the bid fitting within the bid criteria (min/max bid reduction amount, open event time window, etc.), submitting the bid. The result is an instant re-calculation in the system of the lowest bid and the resultant revised ranking of Service Providers for live service request event. Reference is made to FIG. 7H, where these manual and auto-bid choices can be made on an embodiment of a web page of an embodiment of the present invention.

Conversely, the Service Provider may choose to “Auto Bid” at anytime during the live event. By selecting to “Auto-Bid”, the “Manual Bid” option is removed and replaced with the “Auto Bid” box for the Service Provider to view and input their “Auto-Bid” information. The “Auto Bid” functions by the Service Provider placing a “High” and “Low” dollar value which represents the highest and lowest amount the Service Provider is willing to perform work on the service request event. Upon submission, the system will auto-bid on the Service Provider's behalf acting as a stand-in so that the Service Provider must not be present or monitor continuously online The “Auto-Bid” functionality will take into account the current ranking of the service provider, the min/max bid reduction range, as well as the Service Provider's “high” and “low” bid dollar value. The system will automatically lower the bid on the Service Provider's behalf when the Service Provider is not ranked number 1, and the dollar value the Service Provider is willing to pay is lower than the current lowest bid rate while also taking into account the min/max bid reduction rate of the event falls within the parameters above. The system will self-calculate the smallest bid-reduction amount to move the Service Provider into rank #1. This process will occur time and time again continuously until either the Service Provider has won the event, or the “Low” dollar value has been exceeded, or the min reduction amount exceeds the “Low” dollar amount previously set by the Service Provider.

The benefits to the Service Provider utilizing the “Auto-Bid” over the “Manual” functionality are time and economic efficiency. By utilizing and selecting to choose the “Auto-Bid” function, the Service Provider is able to utilize their time and valuable resources (people) more efficiently by doing other things than monitoring and manually bidding on a service request event. By not having to constantly monitor and be online for an active service request event, the Service Provider can benefit from the site acting on their behalf and in their interest without them being online to monitor. Additionally, the “Auto-Bid” functionality enables the Service Provider to benefit from the system placing bids on their behalf that will not exceed/go beyond the most optimal and economically efficient value as defined by the “High” and “Low” values in combination with the pre-established “Min/Max Bid Reduction” values. As such, the economic equilibrium is certain to be reached by the Service Provider utilizing the “Auto-Bid” invention vs. the “Manual” bid not always resulting in achieving economic equilibrium.

It will be understood that while the description has generally been directed to a particular web page or site specific to a reverse auction for services, a reverse auction for services can be hosted within an existing web presence, or newly developing web sites not yet in action, without departing from the novel scope of the present invention. For example, a reverse auction could be implemented within existing auction web sites, such as eBay® by manipulating that system to correspond with the rules established for reverse auctions. The implementation would need to include a gateway wherein the users would have to indicate his understanding that the auction works diametrically different to an ordinary auction in order to enter. Participants may be required to re-register for the site to make sure that they are qualified and understand all of the parameters. In addition, it is within the novel concept of the present invention, to host such a method within an existing social networking site, such as Facebook®; where a host page can be established and participants would tie in a special Facebook® profile made specifically to participate in the method (and other similar methods). Other membership web sites can be used in like style to host the method of the present invention without departing from the novel scope of the present invention.

Specific embodiments of novel methods and apparatus for construction of Method and Device for Reverse Auctions to Facilitate Requesting and Offering of Services according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

Although an illustrative embodiment of the invention has been shown and described, it is to be understood that various modifications and substitutions may be made by those skilled in the art without departing from the novel spirit and scope of the invention.

What is claimed is:

1. A method for offering and securing services and providers to provide the services at a rate acceptable to the provider and receiver of the services, comprising the steps of:
providing an interactive web page on a computer network, comprising servers and communications means, the web page additionally comprising a provider page and a requestor page;
providing a means for one or more service providers to register as a provider of services on the interactive web page;
providing the requestor of services a request page location on the interactive web page to list a request for services, including providing the necessary parameters for the services;
providing the one or more provider of services access to the request page location;
providing a time period for the requested services to be offered;
wherein a requestor of services can enter parameters for services required and start the time period and providers can review the services requested and place a first bid for the desired fees for their services and a subsequent lower bids that are acceptable to the provider for the services during the provided time period; and
receiving notice and a quote of the lowest bid for services among the bids provided by the one or more service providers at the end of the time period.

2. The method for offering and securing services and providers to provide the services at a rate acceptable to the provider and receiver of the services of claim 1, wherein the web page provides a means to exchange consideration such that the quote comprises a contract.

3. The method for offering and securing services and providers to provide the services at a rate acceptable to the provider and receiver of the services of claim 1, wherein the quote is used as the basis of feedback, positive or negative, relative to the provider and receiver of the services.

4. The method for offering and securing services and providers to provide the services at a rate acceptable to the provider and receiver of the services of claim 3, wherein the feedback provided is used by those participating in the method to rate others participating in the method.

5. The method for offering and securing services and providers to provide the services at a rate acceptable to the provider and receiver of the services of claim 1, wherein the provider can decrease the previous bids bid prior to the end of the time period.

6. The method for offering and securing services and providers to provide the services at a rate acceptable to the provider and receiver of the services of claim 1, wherein the receiver of services can create a template for services for use in the method and then reuse the template for other services required.

7. The method for offering and securing services and providers to provide the services at a rate acceptable to the provider and receiver of the services of claim 1, wherein the method can be practiced, both by receiver and provider, on a laptop, desktop, tablet, smartphone or any device having connectivity with the internet.

8. The method for offering and securing services and providers to provide the services at a rate acceptable to the provider and receiver of the services of claim 1, wherein the method comprises a reverse auction in real time.

9. The method for offering and securing services and providers to provide the services at a rate acceptable to the provider and receiver of the services of claim 8, wherein the provider can monitor in real time and add new subsequent lower bids as desired.

10. The method for offering and securing services and providers to provide the services at a rate acceptable to the provider and receiver of the services of claim 1, wherein a database of templates of services is maintained and templates can be recalled for use in the method.

11. The method for offering and securing services and providers to provide the services at a rate acceptable to the provider and receiver of the services of claim 1, wherein the service provider can monitor the bids given in real time so as to provide further bids within the provided time period.

12. The method for offering and securing services and providers to provide the services at a rate acceptable to the provider and receiver of the services of claim 1, including templates having service description information therein such that the elements of the auction are automatically populated therewith.

13. The method for offering and securing services and providers to provide the services at a rate acceptable to the provider and receiver of the services of claim 1, wherein a database of service providers is created by the method.

14. A method for offering and securing services and providers to provide the services at a rate acceptable to the provider and receiver of the services, comprising the steps of:
providing an interactive web page on a computer network, comprising servers and communications means, the web page additionally comprising a provider page and a requestor page and further comprising a legal quote for services;
providing a means for one or more service providers to register as a provider of services on the interactive web page;
providing the requestor of services a request page location on the interactive web page to list a request for services, including providing the necessary parameters for the services;
providing the one or more provider of services access to the request page location;
providing a time period for the requested services to be offered;
wherein the method can be practiced, both by receiver and provider, on a laptop, desktop, tablet, smart phone or any device having connectivity with the internet, and wherein a requestor of services can enter parameters for services required and start the time period and qualified providers can review the services requested and place a first bid for the desired fees for their services and subsequent lower bids as desired that are acceptable to the provider for the services during the provided time period; and
accepting as a quote the lowest bid for services among the bids provided by the one or more service providers at the end of the time period.

15. The method for offering and securing services and providers to provide the services at a rate acceptable to the provider and receiver of the services of claim 14, wherein the web page provides a means to exchange consideration such that the quote comprises a contract.

16. The method for offering and securing services and providers to provide the services at a rate acceptable to the provider and receiver of the services of claim 14, wherein the quote is used as the basis of feedback, positive or negative, relative to the provider and receiver of the services.

17. The method for offering and securing services and providers to provide the services at a rate acceptable to the provider and receiver of the services of claim 16, wherein the feedback provided is used by those participating in the method to rate others participating in the method.
